(19) United States
(12) Patent Application Publication
(10) Pub. No.: US 2022/0364614 A1
(43) Pub. Date: Nov. 17, 2022

(54) METHOD FOR REDUCING VIBRATIONS IN A FRICTION BRAKE, AND BRAKING SYSTEM AND PROGRAM CODE

(71) Applicant: ZF Active Safety GmbH, Koblenz (DE)

(72) Inventors: Andreas Marx, Hartenfels (DE); Frank Gummersbach, Remagen (DE); Torsten Treyde, Neuwied (DE); Martin Janorschke, Kressbronn am Bodensee (DE)

(21) Appl. No.: 17/729,490

(22) Filed: Apr. 26, 2022

(30) Foreign Application Priority Data
May 11, 2021 (DE) 102021112342.9

(51) Int. Cl. F16D 65/00; F16D 65/092

(52) U.S. Cl. CPC F16D 65/0018; F16D 65/092

(57) ABSTRACT

The disclosure relates to a method for reducing unwanted vibrations in a friction brake. The friction brake has at least one friction surface and at least one brake lining associated with the friction surface. The method comprises the following steps: a) pressing the brake lining against the friction surface with a clamping force in order to convert a braking request into a braking force; and b) modulating a temporal fluctuation onto the clamping force in order to avoid or reduce the unwanted vibrations. A corresponding braking system together with the associated program code is also disclosed.

### CROSS-REFERENCE TO RELATED APPLICATION

This application claims priority to German Priority Application No. 102021112342.9, filed May 11, 2021, the disclosure of which is incorporated herein by reference in its entirety.

### TECHNICAL FIELD

The disclosure relates to a method for reducing unwanted vibrations in a friction brake. Furthermore, the disclosure relates to a braking system for a land vehicle, in, for example, for a motor vehicle. The disclosure also relates to program code having commands which, when executed by a controller, cause the braking system to carry out the method according to the disclosure.

### BACKGROUND

Friction brakes are known from the prior art. Friction brakes are used to reduce or limit the speed of moving machine parts or vehicles. When braking, kinetic energy is converted into thermal energy via friction. By far the most commonly used friction brakes in vehicles are the disk brake and the drum brake, a further developed form of a block brake. A service brake system of vehicles is usually operated hydraulically or pneumatically and recently also increasingly electromechanically.

Unwanted vibrations can occur during the braking process. In the motor vehicle sector, these vibrations are also known, e.g. depending on the frequency, as “rubbing” (at frequencies below 100 Hz), “creaking” or “mooing” (100 Hz to 500 Hz), “howling” (500 Hz to 1,000 Hz), “low-frequency squeaking” (1,000 Hz to 4,000 Hz) and “high-frequency squeaking” (4,000 Hz to 20,000 Hz). These vibrations are noticeable to the driver and passengers, for example as brake pedal pulsations, steering wheel torsional oscillations, vibrations or noises.

Increasing demands on driving comfort, in particular also with respect to a low noise level in the interior of the vehicles, require a continuously advancing optimization of noise avoidance or noise damping.

This trend is also supported by a change in mobility toward hybrid and electric vehicles. With the elimination of engine noise from internal combustion engine, driving and braking noises are perceived much more strongly and, in some instances, are perceived as annoying by the driver and passengers due to the resulting lack of noise masking.

The introduction of autonomously controlled vehicles onto the market will also increasingly allow the driver to carry out noise-sensitive activities while driving and to use communication and entertainment technology to an extent that was previously not possible.

In addition to drive, rolling and wind noise, the optimization thus also focuses on vibration-induced noise at the wheel-side braking devices.

In order to reduce unwanted vibrations in the brakes, mechanical solutions with vibration-damping properties are primarily used. These can be implemented, for example, by a ground coupling, spring elements and/or damper elements. Another means of avoiding unwanted vibrations is to vary the geometry of the lining friction surfaces on the braking device.

DE 2 229 258 C3, for example, discloses a brake disk having a device for damping high-frequency vibrations (squeaking).

DE 3 333 670 C2 also relates to the reduction of high-frequency brake noises at frequencies from 3,000 Hz on a floating caliper brake. To this end, it is proposed to arrange damping elements on the lining backing plates.

DE 10 2016 215 892 A1 proposes a different approach; however, the aim here is not to avoid high-frequency squeaking, but to avoid low-frequency vibrations (creaking). The front axle brake pressure is reduced in relation to the rear axle brake pressure so that the creaking on the front axle is reduced as much as possible. The basic idea is that creaking is particularly annoying on the front axle due to the vibrations transmitted to the steering wheel. However, shifting the brake pressure to the rear axle is effective only within a very narrow range of parameters.

### SUMMARY

Against this background, a problem addressed by the disclosure is that of providing an improved method for avoiding or reducing unwanted vibrations in a friction brake.

The problem is solved by a method for reducing unwanted vibrations in a friction brake. Such a friction brake usually comprises at least one friction surface and at least one brake lining associated with the friction surface. In one exemplary arrangement of the disclosure, the method comprises a) pressing a brake lining against the friction surface with a clamping force in order to convert a braking request into a braking force, and b) modulating a temporal fluctuation onto the clamping force in order to avoid or reduce unwanted vibrations.

Studies have shown that unwanted vibrations, in particular braking noises such as high-frequency squeaking, can be completely avoided or at least reduced by a fluctuation modulated onto the clamping force.

The term modulation (from Latin modulatio=cycle, rhythm) describes in this context a process in which the clamping force is changed (modulated) by a repeatedly rising and falling deviation from an average value.

The rate of change of the fluctuation is usually significantly (in the sense of at least one order of magnitude) greater than the rate of change of the clamping force itself.

The clamping force remains (substantially) unchanged by the modulated fluctuation on average over time. In other words, an upward fluctuation from the average value is offset by an equally large downward fluctuation from the average value. Thus, the braking or deceleration effect desired for the vehicle, which results from the conversion of a braking request into a braking force, is not impaired by the modulated fluctuation.

In one exemplary arrangement, the modulated fluctuation has a continuous, and in one example, a substantially sinusoidal curve. In a series of tests it was found that this type of curve leads to particularly good results in terms of vibration suppression.

According to exemplary arrangement, the modulated fluctuation can oscillate at a frequency of approximately 0.1 Hz to 250 Hz. In one exemplary arrangement, the modulated fluctuation can oscillate at a frequency of 5 Hz to 70 Hz. While even higher frequencies put a heavy load on the braking system, lower frequencies often no longer lead to the desired result.

The frequency of the modulated fluctuation can be changed over time. For example, the fluctuation can have alternating positive and negative chirps. In other words, the fluctuation can “wobble”; the frequency of the fluctuation can therefore vary cyclically between a lower frequency and an upper frequency. The lower and upper frequency can be selected on the basis of the damping force.

In one exemplary arrangement, the frequency of the modulated fluctuation can change as the clamping force increases, or, in other words, the frequency of the modulated fluctuation can be adapted to the damping force. This improves driving comfort in vehicles.

According to one exemplary arrangement, an amplitude of the modulated fluctuation may be at most 50% of the clamping force, and in one exemplary arrangement, at most 35% of the clamping force. Higher amplitudes often lead to a negative driving experience, particularly in motor vehicles, and would therefore be clearly perceptible to the driver and passengers.

In one exemplary arrangement, an amplitude of the modulated fluctuation can change as the clamping force increases, or, in other words, an amplitude of the modulated fluctuation can be adapted to the clamping force. This aspect also helps ensure good driving comfort in vehicles. For example, the amplitude can decrease when a stored limit clamping force is reached.

In principle, the modulation of the temporal fluctuation onto the damping force can take place permanently, since the clamping force remains (substantially) unchanged by the modulated fluctuation on average over time. The detection of a braking condition that is susceptible to vibrations would therefore not be necessary. The frequency and/or amplitude of the modulated fluctuation which is/are required to avoid or reduce certain unwanted vibrations can be determined when the braking system is applied to the vehicle, i.e. before the vehicle is used in series production. In addition, adaptive control of the frequency and/or amplitude of the modulated fluctuation can be provided. If, for example, when applying the braking system, it is determined that unwanted vibrations occur exclusively or predominantly in a certain speed or deceleration range, the adaptive control of the frequency and/or amplitude of the modulated fluctuation can be dependent on the driving state of the vehicle, in particular the vehicle deceleration and/or the vehicle speed.

In one exemplary arrangement, the temporal fluctuation can be modulated onto the clamping force only when a braking state that is susceptible to vibrations is present. For this purpose, the method comprises c) detecting a braking state which is susceptible to vibrations and in which unwanted vibrations can occur, and d) modulating temporal fluctuation onto the clamping force when the braking state that is susceptible to vibrations is detected.

The detection of a braking state that is susceptible to vibrations can include evaluating a sensor signal from a sensor. The sensor can be fastened directly in or on the friction brake. The sensor can be e.g. an accelerometer, a sound meter (microphone) or a magnetic field sensor. Unwanted vibrations can be detected particularly well by choosing a suitable installation location.

The evaluation of the sensor signal can include a determination of the frequency and/or amplitude and/or phase position of dominant unwanted vibrations in the friction brake. With knowledge of the values mentioned, a suitable fluctuation curve for suppressing vibrations can be selected or determined. In this way, the curve of the modulated fluctuation can be formed on the basis of the frequency, amplitude and/or phase position of one or more dominant unwanted vibrations in the friction brake.

In one exemplary arrangement, the method can be used to reduce unwanted vibrations in a friction brake pair having a first and a second friction brake. For this purpose, the first and the second friction brake can each be operated with the previously described method for reducing unwanted vibrations.

In one exemplary arrangement, the respective modulated fluctuations can have an antiphase curve with respect to another in terms of the friction brakes. In other words, a phase offset of 180 degrees can be provided between the modulated fluctuations. In this way, the driving comfort in a vehicle is improved since, on account of the antiphase fluctuations, an overall more even braking force curve is produced and rubbing induced by the method according to the disclosure is avoided.

A braking system is also provided, in particular for a motor vehicle. The braking system comprises a controller, an energy source and at least one friction brake with an associated actuator.

The actuator is designed to press a brake lining of the friction brake against an associated friction surface of the friction brake with a clamping force. The energy source is designed to supply the actuator with energy. The controller is in turn designed to control the actuator and to carry out the steps of the method according to the disclosure. Such a braking system can reliably avoid or at least reduce vibrations in the friction brakes.

In one exemplary arrangement, the at least one friction brake is associated with a sensor which provides the sensor signal. In particular, the friction brake can comprise the sensor. The sensor can be a sound meter (microphone), a magnetic field sensor or an accelerometer. In this way, unwanted vibrations can be detected particularly easily.

In one exemplary arrangement of the braking system and/or the method, the friction brake is an electromechanical brake. Electromechanical brakes are particularly suitable because they have a significantly lower inertia than hydraulic or pneumatic brakes and are therefore also well suited for modulated fluctuations with higher frequencies.

A program code is also provided and has commands which, when executed by the controller, have the effect that the braking system described above can carry out the method likewise described. In this way, unwanted vibrations in the brakes can be avoided or at least reduced without further structural measures.

### BRIEF DESCRIPTION OF DRAWINGS

The disclosure is explained below with reference to an exemplary arrangement which is shown in the accompanying drawings, in which:

FIG. 1 is a highly simplified schematic view of a braking system according to the disclosure, which is operated in accordance with the method according to the disclosure, and

FIG. 2 is a diagram showing a modulated clamping force schematically plotted against a (nominal) clamping force.

### DETAILED DESCRIPTION

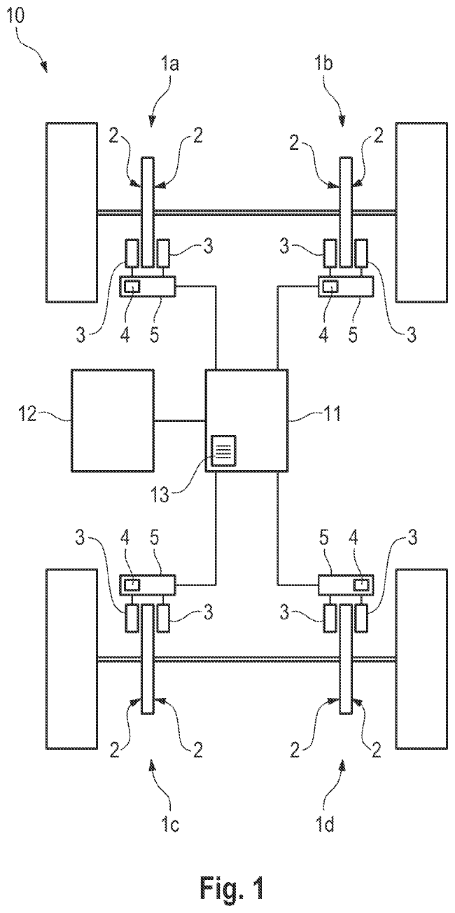

FIG. 1 shows a braking system 10 for a motor vehicle comprising a plurality of friction brakes 1a-1d. Each friction brake 1a-1d has at least one friction surface 2, for example on flanks of a brake disk. In addition, each friction brake comprises at least one brake lining 3. The brake linings 3 are also referred to as brake pads or friction linings, among other things.

In addition to the friction brakes 1a-1d, the braking system 10 comprises a controller 11, an energy source 12 and at least one actuator 5 associated with the relevant friction brake 1a-1d.

Each actuator 5 is designed to press the associated brake lining 3 of the friction brake 1a-1d against the corresponding friction surface 2 of the friction brake with a clamping force. The energy source 12 is designed to supply the actuator 5 with energy.

The friction brakes 1a-1d are electromechanical brakes, i.e. those in which an electric motor acts directly on the brake linings via a gear mechanism.

The controller 11 is designed to control the actuator 5 and to carry out the steps of the method according to the disclosure. The controller 11 can be a conventional controller in the true sense or can also provide the function of an open-loop controller with a corresponding feedback path.

A sensor 4 which provides a sensor signal can be associated with the friction brakes 1a-1d. The sensor signal is processed by the controller 11. One sensor 4 can be associated with a plurality of friction brakes 1a-1d. Alternatively, as shown here, each friction brake 1a-1d can be associated with its own sensor 4. In one exemplary arrangement, the sensors are acceleration sensors which are arranged directly on or in a component of the friction brake 1a-1d and can detect vibrations of the friction brake 1a-1d.

However, unwanted vibrations can also be detected by other suitable sensors, for example microphones or magnetic field sensors.

A program code 13 having commands is stored in a memory of the controller 11 and, when executed by the controller 11, causes the braking system 10 to carry out the method according to the disclosure.

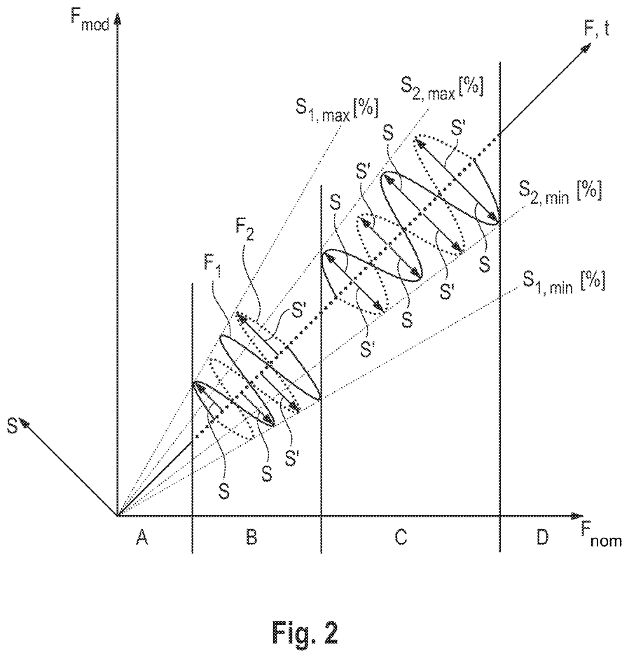

FIG. 2 shows a diagram with the modulated clamping force F_mod plotted schematically over the nominal clamping force F_nenn. Along the diagonal between the nominal clamping force F_nenn and the modulated clamping force F_mod, the clamping force is thus represented as an average over time. The time t for the schematic representation of the oscillation is also plotted along the diagonal between the nominal clamping force F_nenn and the modulated clamping force F_mod. The amplitude of the fluctuation S or of the antiphase fluctuation S′ is plotted transversely to said diagonal.

In principle, the brake linings 3 are pressed against the friction surfaces 2 with a clamping force F in order to convert a braking request from the driver or an autopilot into a braking force. As the clamping force F increases, so does the braking force on the contact area of the tire.

Here, in a first range A with a very low nominal clamping force, the probability of an unwanted vibration is so low that it is not absolutely necessary to modulate a fluctuation onto the nominal clamping force. The actual clamping force thus corresponds to the nominal clamping force F_nenn.

In order to reduce unwanted vibrations in one of the friction brakes 1a-1d, it is first ascertained or detected whether a braking state at risk of vibrations is present, in which unwanted vibrations can occur. Unwanted vibrations are in particular those that cause annoying noises and/or vibrations.

A temporal fluctuation S is then modulated onto the damping force F as long as the braking state susceptible to vibrations is detected in order to avoid or reduce the unwanted vibrations.

For example, unwanted vibrations can occur in a second range B with a low nominal damping force. This is therefore an operating state that is susceptible to vibrations. As soon as a vibration is detected or is determined to be imminent, a temporal fluctuation S1 is therefore modulated onto the nominal damping force of a first friction brake 1a. The damping force F is substantially unchanged by the modulated fluctuation S on average over time. Small fluctuations cannot be avoided for technical reasons.

In one exemplary arrangement, the modulated fluctuation S has a continuous, substantially sinusoidal curve.

A temporal fluctuation S1′ with an antiphase curve is modulated onto the nominal damping force of a second friction brake.

The second friction brake 1b can be located on the same front or rear axle as the first friction brake 1a.

The second friction brake can, however, also be the friction brake 1d diagonally opposite the first friction brake 1a, in order to achieve even greater driving stability. If, for example, a vibration is determined on the front left friction brake 1a, a fluctuation is modulated onto the rear right friction brake 1d with an antiphase.

Of course, it is also conceivable that the first friction brake 1a and the second friction brake 1c are arranged one behind the other on one side of a vehicle.

Unwanted vibrations can also occur in a third range C with an average nominal damping force. In principle, this range still involves comfort braking. This is also an operating state that is susceptible to vibrations. A temporal fluctuation S2 is therefore modulated onto the nominal clamping force of the first friction brake 1a. A complementary or antiphase fluctuation S2′ is likewise modulated onto the nominal damping force of the second friction brake 1b, 1c or 1d.

The damping force F is also substantially unchanged by the modulated fluctuation S on average over time here. In one exemplary arrangement, the modulated fluctuation S has a continuous, substantially sinusoidal curve.

For reasons of comfort, the maximum amplitude of the fluctuation S2,max or S2,min (as a percentage of the nominal clamping force F_nenn) in the third range C is selected to be lower than the maximum amplitude of the fluctuation S1,max or S1,min (also as a percentage of the nominal damping force F_nenn) in the second range.

The modulated fluctuation S oscillates at a frequency of approximately 0.1 Hz to 250 Hz, in particular at a frequency of 3 Hz to 70 Hz. In contrast with hydraulic/pneumatic brakes, electromechanical brakes can convert frequencies of more than 10 Hz without major problems.

The frequency in the second range B can be 30 Hz, for example.

Furthermore, the frequency can decrease as the damping force F increases. For example, the frequency in the third range C can be 10 Hz.

The amplitude of the modulated fluctuation S is at most 50% of the clamping force F, and in one exemplary arrangement, at most 35% of the damping force F.

In the second range B, the amplitude S1,max can be, for example, 20% of the nominal damping force.

The amplitude of the modulated fluctuation S decreases as the damping force F increases. The amplitude S2,max in the third range C is for example 15% of the nominal damping force and does not exceed a certain absolute value.

In one exemplary arrangement, the frequency of the modulated fluctuation S is changed over time. For example, it can in particular have alternating positive and negative chirps. In other words, the frequency can wobble in a chirp modulation between a minimum frequency and a maximum frequency. In one exemplary arrangement, the minimum frequency can be 20 Hz and the maximum frequency can be 40 Hz. The transition from the minimum to the maximum and back again to the minimum frequency can last for approximately 2 seconds in the second range B, for example at an amplitude F1,max of 35%. Correspondingly lower values are to be selected in the third range C, for example an amplitude of 20%, a maximum frequency of 25 Hz and a minimum frequency of 10 Hz.

In a fourth range D with a high nominal clamping force F_nenn, it is no longer a question of comfort braking in the true sense. The driver and passengers of a vehicle are usually distracted in such a situation and accordingly more tolerant of noise. It is therefore not absolutely necessary here to modulate a fluctuation onto the nominal clamping force F_nenn in this range. Also, if the clamping force F is sufficiently strong, strong unwanted vibrations are not expected. The actual clamping force therefore corresponds to the nominal clamping force F_nenn.

Deviating advantageous fluctuation curves over the nominal clamping force are conceivable, in particular those in which the amplitude, frequency and/or phase position of the fluctuation curve is determined dynamically.

Optionally, the detection of a braking state that is susceptible to vibrations includes evaluating a sensor signal from a sensor 4. As an example, the sensor is an acceleration sensor. However, other types of sensors can also be considered.

The evaluation of the sensor signal can include a determination of the frequency, amplitude and/or phase position of dominant unwanted vibrations in the friction brake or brakes 1a-1d.

The curve of the modulated fluctuation S is then formed on the basis of the frequency, amplitude and/or phase position of one or more dominant unwanted vibrations in the friction brake or brakes 1a-1d.

1. A method for reducing unwanted vibrations in a friction brake, wherein the friction brake has at least one friction surface and at least one brake lining associated with the friction surface, and wherein the method comprises the following steps:
a) pressing the brake lining against the friction surface with a clamping force in order to convert a braking request into a braking force, and
b) modulating a temporal fluctuation onto the clamping force in order to avoid or reduce unwanted vibrations.

2. The method according to claim 1, wherein the clamping force remains substantially unchanged by the modulated fluctuation on average over time.

3. The method according to claim 2, wherein the modulated fluctuation has a continuous curve.

4. The method according to claim 2 wherein the modulated fluctuation oscillates at a frequency of approximately 0.1 Hz to 250 Hz.

5. The method according to claim 4, wherein the frequency of the modulated fluctuation changes over time, and has alternating positive and negative chirps, as the clamping force increases.

6. The method according to claim 1, wherein an amplitude of the modulated fluctuation is at most 50% of the clamping force.

7. The method according to claim 1, wherein an amplitude of the modulated fluctuation changes as the clamping force increases.

8. The method according to claim 1, wherein the method further comprises the following steps:
c) detecting a braking state which is susceptible to vibrations and in which unwanted vibrations can occur, and
d) modulating the temporal fluctuation onto the clamping force when the braking state that is susceptible to vibrations is detected.

9. The method according to claim 8, wherein the detection of a braking state that is susceptible to vibrations includes evaluating a sensor signal from a sensor-.

10. The method according to claim 9, wherein the evaluation of the sensor signal includes a determination of the frequency, amplitude and/or phase position of dominant unwanted vibrations in the friction brake.

11. The method according to claim 1, wherein a curve of the modulated fluctuation is formed on the basis of the frequency, amplitude and/or phase position of one or more dominant unwanted vibrations in the friction brake.

12. The method for reducing unwanted vibrations in a friction brake pair having a first and a second friction brake, wherein the first and the second friction brake are each operated with the method for reducing unwanted vibrations according to claim 1, wherein the respective modulated fluctuations have an antiphase curve.

13. A braking system for a land vehicle, comprising a controller, an energy source and at least one friction brake with an associated actuator, wherein the actuator is designed to press a brake lining of the friction brake against an associated friction surface of the friction brake with a clamping force, wherein the energy source is designed to supply the actuator with energy, and wherein the controller is designed to control the actuator to a) cress the brake lining against the friction surface with a clamping force in order to convert a braking request into a braking force, and b) modulate a temporal fluctuation onto the clamping force in order to avoid or reduce unwanted vibrations.

14. The braking system according to claim 13, the at least one friction brake is associated with a sensor which provides a sensor signal, wherein the friction brake comprises the sensor.

15. The braking system according to claim 13, wherein the friction brake is an electromechanical brake.

16. A program code comprising commands which, when executed by a controller, cause a braking system to carry out the method according to claim 1.

17. The program code of claim 15, wherein the braking system comprising a controller, an energy source and at least one friction brake with an associated actuator, wherein the actuator is designed to press a brake lining of the friction brake against an associated friction surface of the friction brake with a clamping force, wherein the energy source is designed to supply the actuator with energy, and wherein the controller is designed to control the actuator

18. The method according to claim 3, wherein the curve of the modulated fluctuation is a continuous substantially sinusoidal curve.

19. The method according to claim 2, wherein the modulated fluctuation oscillates at a frequency of approximately 3 Hz to 70 Hz.

20. The method according to claim 1, wherein an amplitude of the modulated fluctuation is at most 35% of the clamping force.
